(19) United States
(12) Patent Application Publication
(10) Pub. No.: US 2007/0182700 A1
(43) Pub. Date: Aug. 9, 2007

(54) IMAGE DISPLAY DEVICE AND IMAGE DISPLAY METHOD

(75) Inventors: Masahiro Baba, Minato-ku, Tokyo (JP); Goh Itoh, Minato-ku, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/620,166

(22) Filed: Jan. 5, 2007

(30) Foreign Application Priority Data
Feb. 6, 2006 (JP) 2006-28924

(51) Int. Cl. G09G 3/36

(52) U.S. Cl. 345/102

(57) ABSTRACT

A liquid crystal panel for displaying an input image and a black image during one frame period, a target black display period ratio calculating unit configured to obtain a black image display period occupying one frame period of the input image, a black display period ratio change amount calculating unit configured to obtain the amount of change in ratio of black display period for each of one or a plurality of frames, a black display period ratio determining unit configured to calculate the ratio of black display period for an actual display, a black display period control unit configured to control a period for displaying the input image and the black image on the image display unit, and a display luminance control unit configured to restrain variations in luminance of the image display unit during one frame period within a predetermined range are provided.

### CROSS-REFERENCE TO RELATED APPLICATIONS

This application is based upon and claims the benefit of priority from the prior Japanese Patent Application No. 2006-28924, filed on Feb. 6, 2006; the entire contents of which are incorporated herein by reference.

### TECHNICAL FIELD

The present invention relates to an image display device in which the quality of a moving image and a still image is improved while restraining increase in power consumption.

### BACKGROUND OF THE INVENTION

In recent years, a technical advancement of a flat panel display device such as liquid crystal display device or an organic EL (Electro Luminescence) display has been in progress, and it starts to be generalized in a TV field in which a cathode ray tube (hereinafter, referred to as CRT) has been a mainstream technology.

However, the liquid crystal display device and the organic EL display have a problem such that the image appears to be blurred when the moving image is displayed. This problem is caused by the fact that temporal characteristics of an image display method are different between the liquid crystal display device or the organic EL display and the CRT. The cause of this problem will be described in detail below.

The liquid crystal display device or the organic EL display in which a transistor is used as a selection switch for display/non-display for each pixel is a display device in which a display method in which a displayed image is held for one frame period (hereinafter, referred to as a hold-type display) is employed. On the other hand, the CRT is a display device in which a display method in which each pixel becomes dark after having illuminated for a certain period (hereinafter, referred to as an impulse-type display) is employed.

In the case of the hold-type display, the same image is kept displayed from the timing when a certain frame of the moving image is displayed until the timing when the next frame thereof is displayed. From the timing when a frame N in the moving image is displayed until the timing when the next frame N+1 is displayed (between frames), the image of the frame N is kept displayed. When a moving object is in the moving image, the moving object stands still on a screen from the timing when the frame N is displayed until the frame N+1 is displayed. When the frame N+1 is displayed, the moving object moves discontinuously.

On the other hand, when an observer keeps his/her eyes on the moving object, and observes the moving object while following the movement thereof (when the eyeball movement of the observer is a following movement), the observer moves his/her eyeballs and tries to follow the movement of the moving object continuously and smoothly without consciousness.

Then, a difference is generated between the movement of the moving object on the screen and the movement of the moving object that the observer assumes. Due to this difference, the blurred image is presented to the retina of the observer according to the speed of the moving object. The observer perceives misaligned images formed by superimposing the misaligned images, and hence he/she gets the impression that the moving image is blurred.

The higher the speed of the moving image, the larger the blurring of the image perceived on the retina of the observer becomes. Therefore, the observer gets the impression of blurring to a larger extent.

In the case of the impulse-type display, such the blurring does not occur. In the case of the impulse-type display, black color is displayed between the frames of the moving image (for example, between the above-described frame N and the frame N+1).

Since the black color is displayed between the frames, even when the observer moves his/her eyeballs to follow the moving object smoothly, the observer cannot see the image other than the moments when the images are displayed. Since the observer recognizes each frame of the moving image as independent images, the blurring does not occur in the image perceived on the retina.

In order to solve the above-described problem in the display device in which the hold-type display is carried out, a first method of displaying “black” in one way or another after displaying a frame is proposed in the related art (for example, see JP-A-11-109921)

A second method of determining whether an input image is a moving image or a still image and displaying black between continuous frames only when it is the moving image is also proposed in the related art (for example, see JP-A-2002-123223).

In the first method in the related art, a pseudo-impulse-type display is carried out such as the CRT by intentionally turning the liquid crystal screen black between frames to restrain deterioration of the moving image quality. However, the power consumption of a backlight which is illuminated during the black display as well is wasteful. In the still image display, there is a problem that flicker caused by the impulse-type display occurs.

In the second method in the related art, a control to switch to the hold-type display when displaying the still image and to the impulse-type display when displaying the moving image is carried out in order to solve the above-described problem. However, in this method, for example, the black is displayed both for the slow moving image and the quick moving image. Therefore, a sufficient reduction of power consumption cannot be achieved. It is possible to shift the criteria between the moving image and the still image toward the moving image in order to increase the effect of reduction of power consumption. In this case, however, the quality of the moving image is lowered. In addition, there is a problem such that an abrupt change in ratio of black display period (black display period/one frame period) such as the switching between the impulse-type display and the hold-type display is viewed by the observer as the flicker, and hence the lowering of the image quality is resulted.

### SUMMARY OF THE INVENTION

In view of such problems as described above, it is an object of the invention to provide an image display device and an image display method in which the quality of a moving image and a still image displayed on a liquid crystal display device is improved while restraining increase in power consumption.

According to embodiments of the present invention, an image display device including:

an image display unit;

a target value calculating unit for calculating a target value of the ratio of black which corresponds to a ratio of black display period occupied in one frame period of an input image;

an amount of change calculating unit for obtaining an amount of change per unit period of a current value of the ratio of black within a range in which occurrence of flicker in the unit period can be restrained on the basis of (1) differential between the target value and a current value of a previous frame or (2) differential between the target value and the target value obtained in the past;

a current value calculating unit for obtaining a current value for displaying a current frame by adding the amount of change to the current value of the previous frame; and

a control unit for dividing the one frame period into two periods of (1) a first period which corresponds to the current value of the current frame and (2) a second period which corresponds to a remaining period of the first period and making a control to cause the image display unit to display a black image during the first period and to cause the image display unit to display an image on the basis of the input image during the second period.

According to the present invention, the quality of the moving image and the still image displayed on the image display device can be improved as much as possible while restraining increase in power consumption and the flicker.

### BRIEF DESCRIPTION OF THE DRAWINGS

FIG. 1 is a block diagram of a liquid crystal display device according to a first embodiment of the invention;

FIG. 2 is a graph showing a relation between the relative luminance and time when the ratio of the image display period is changed from t0 to t1 (t0<t1);

FIG. 3 is a graph showing a relation between the relative integrated luminance and time when the ratio of image display period is changed from t0 to t1 (t0<t1);

FIG. 4 is a graph showing a relation between the relative luminance and time when the ratio of image display period is changed from t0 to t1 (t0>t1);

FIG. 5 is a graph showing a relation between the relative integrated luminance and time when the ratio of image display period is changed from t0 to t1 (t0>t1);

FIG. 6 is an explanatory drawing of an array substrate of the liquid crystal display device;

FIG. 7 shows a display signal outputted from a signal line drive circuit, a drive waveform of a scanning line signal outputted from a scanning line drive circuit, and an image displayed state on a liquid crystal panel;

FIG. 8 shows a state on the liquid crystal panel when the ratio of black display period is 50%;

FIG. 9 shows a relation among the ratio of black display period, a relative transmissivity of the liquid crystal panel 26,the relative luminance of a backlight, and the relative luminance of the liquid crystal display device in a case in which a range of the ratio of black display period is set to 0% to 50%;

FIG. 10 is a block diagram showing the liquid crystal display device according to a fourth embodiment;

FIG. 11 is a sequence diagram of the liquid crystal panel and the backlight;

FIG. 12 is a block diagram of the liquid crystal display device according to a fifth embodiment;

FIG. 13 is a drawing showing a structure of the backlight;

FIG. 14 is a sequence diagram of the liquid crystal panel and the backlight;

FIG. 15 is a diagram showing a configuration of an organic EL display according to a sixth embodiment; and

FIG. 16 is an explanatory drawing of an organic EL panel.

### DESCRIPTION OF THE PREFERRED EMBODIMENTS

### First Embodiment

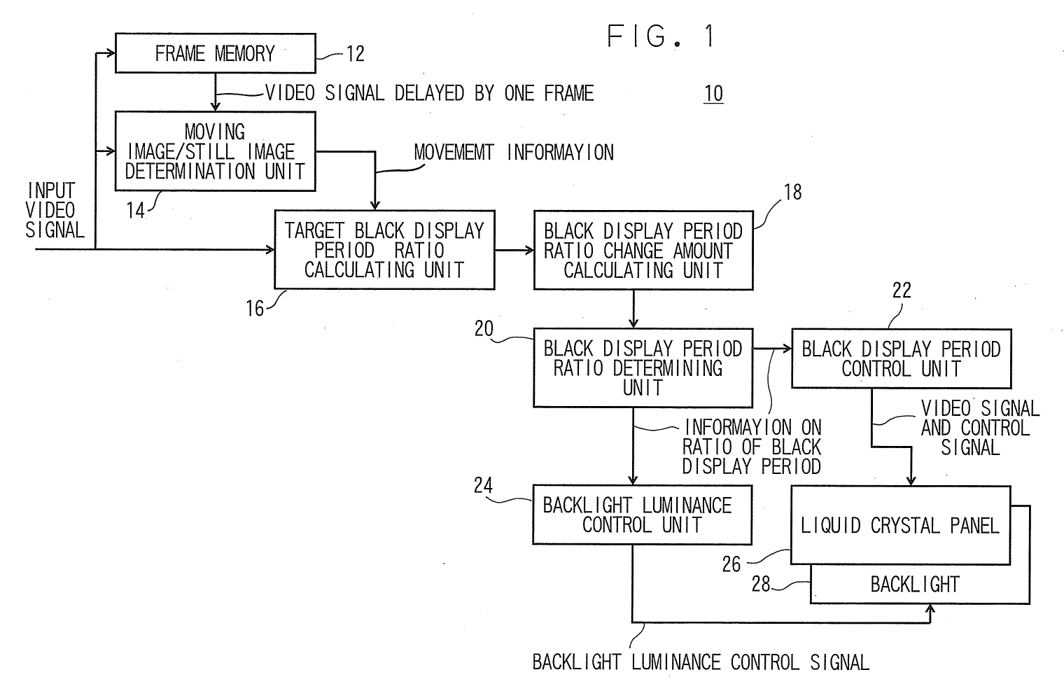

Referring now to FIG. 1 to FIG. 9, a liquid crystal display device 10 according to a first embodiment of the invention will be described.

(1) Configuration of the liquid crystal display device

FIG. 1 shows a configuration of the liquid crystal display device 10.

An input video signal is supplied to a frame memory 12, a moving image/still image determination unit 14, and a target black display period ratio calculating unit 16.

The frame memory 12 holds the input video signal for one frame period, and outputs the same to the moving image/still image determination unit 14 as a video signal delayed by one frame. The term “one frame” corresponds to a piece of image displayed on the liquid crystal display device 10, and the term “one field” which is generally referred regarding an interlace video signal and the term “one frame” here are identical.

The moving image/still image determination unit 14 detects a magnitude of the movement between temporally adjacent two frames using the input video signal and the video signal delayed by one frame period by the frame memory 12, and outputs the result to the target black display period ratio calculating unit 16 as movement information.

The target black display period ratio calculating unit 16 calculates the ratio of black display period in one frame period of black display which is displayed between frames of the input video signal displayed on the liquid crystal panel 26 on the basis of the input movement information, and outputs the result to a black display period ratio change amount calculating unit 18 as information on discrete target ratios of black display period.

The black display period ratio change amount calculating unit 18 calculates the amount of change in ratio of black display period per one frame on the basis of the ratio of black display period in the past frame and the supplied discrete target ratios of black display period, and outputs the same to a black display period ratio determining unit 20.

The black display period ratio determining unit 20 adds the supplied amount of change in ratio of black display period to the ratio of black display period in the previous frame to determine the ratio of black display period for performing actual display, and outputs the same to a black display period control unit 22 and a backlight luminance control unit 24.

The black display period control unit 22 outputs the video signal to be displayed on the liquid crystal panel 26 and a control signal for driving the liquid crystal panel 26 (horizontal synchronous signal, vertical synchronous signal, and so on) to the liquid crystal panel 26 on the basis of the supplied ratio of black display period.

The backlight luminance control unit 24 determines the luminance of a backlight 28 on the basis of the supplied ratio of black display period and outputs the same to the backlight 28 as a backlight luminance control signal.

The liquid crystal panel 26 displays a video signal in which black displays are inserted between the frames on the basis of the input video signal and the control signal.

The backlight 28 is emitted at a luminance on the basis of the backlight luminance control signal.

(2) Operation of the Respective Units

Subsequently, the operation of the respective units 12 to 28 will be described. The moving image/still image determination unit 14, the target black display period ratio calculating unit 16, the black display period ratio change amount calculating unit 18, the black display period ratio determining unit 20, the black display period control unit 22 and the backlight luminance control unit 24 in this embodiment are realized by a timing controller IC of the liquid crystal display device. However, they may be realized by causing a computer to implement programs having these functions.

(2-1) Moving Image/still Image Determination Unit 14

The moving image/still image determination unit 14 detects the moving image/still image using a plurality of frames in the input video signal and outputs the same as movement information.

In this embodiment, the input video signal is held for one frame period in the frame memory 12, and the moving image/still image is detected using the video signal delayed by one frame and the input video signal, that is, the temporally adjacent two frames. However, the frames for detecting the moving image/still image are not limited to the two temporally adjacent two frames, and, for example, in a case in which the input video signal is an interlaced video signal, detection of the moving image/still image can be performed using only even fields or odd fields. Although moving image/still image detecting means may be of various types, in this embodiment, the sum of absolute differences (SAD) between the two frames is employed as the movement information. In other words, the sum of absolute differences of the N^{th} frame and the N+1^{st} frame in the case in which the number of horizontal pixels is X and the number of vertical pixels is Y is expressed by Expression 1.

$$SAD = {\sum }_{u = 1}^{X} {\sum }_{v = 1}^{Y} \vert f ( u , v , N ) - f ( u , v , N + 1 ) \vert \qquad [ Expression 1 ]$$

SAD represents the sum of absolute differences and f(u, v, n) represents the value Y of the pixel at a position (u, v) of the n^{th} frame. F(u, v, n) is expressed as in Expression 2 as a linear sum of the pixel values (tones) of red, green and blue.
f(u,v,n)=0.299R(u,v,n)+0.587G(u,v,n)+0.114B(u,v,n) [Expression 2]

R(u, v, n), G(u, v, n) and B(u, v, n) represent the pixel values of red, green and blue in the positions (u, v) respectively.

In this embodiment, the sum of absolute differences of the value Y is obtained. However, a configuration to obtain the sum of absolute differences of the pixel values of red, green and blue is also applicable.

In this embodiment, the sum of absolute differences is obtained for all the pixels in one frame. However, in order to simplify the process, a configuration in which the sum of absolute differences is obtained for discrete pixels is also applicable.

A configuration in which one frame is sub sampled, and the sum of absolute differences is obtained for a sub sampled image is also applicable.

A configuration in which the sum of absolute differences between frames may be obtained every two frame, or other several frames other than between the adjacent frames is also applicable.

Furthermore, in order to make the movement more robust, a method of determining the movement information of the current frame using the movement information of several frames in the past may be employed. For example, a median value processing is performed from the movement information of the past five frames, and the movement information of the median values is employed as the movement information of the current frame.

By the process as described above, a departed value generated by failure of movement detection is excluded by the median value processing. Then, the sum of absolute differences obtained by Expression 1 is supplied to the target black display period ratio calculating unit 16.

(2-2) Target Black Display Period Ratio Calculating Unit 16

The target black display period ratio calculating unit 16 calculates the discrete target ratios of black display period on the basis of the input movement information.

In this embodiment, the target ratio of black display period is obtained as the continuous values from a movement information value (that is, the target value).

Then, the target ratio of black display period in continuous values is discretized by the threshold processing to obtain the discrete target ratios of black display period (that is, the target discretization value) as shown in Expression 3.

$${B}_{D} ( N ) = \{ \begin{matrix}0 & {B}_{T} ( N ) < Th \\ 0.5 & otherwise\end{matrix} \qquad [ Expression 3 ]$$

Here, B_{D}(N) represents the discrete target ratio of black display period of the N^{th} frame, and B_{T}(N) represents the target ratio of black display period of the N^{th} frame, and Th represents a threshold value used for the discretization.

The relation between the target ratio of black display period and the value of the movement information may be set in advance such that the target ratio of black display period becomes a large value when the movement information value is large. The target ratio of black display period is preferably processed so as to fall between a minimum value in the discrete target ratio of black display period and a maximum value in the discrete target ratio of black display period. In this embodiment, the discrete target ratios of black display period are set to 0% as the minimum value and 50% as the maximum value.

However, when the threshold value is a fixed value, the discrete target ratios of black display period may be 0% or 50% from frame to frame if the value of the target ratio of black display period is a value near the threshold value. Therefore, the threshold value is varied according to the discrete target ratios of black display period of the previous frame and the target ratio of black display period of the current frame as shown in Expression 4.

$$Th = \{ \begin{matrix}Th & {B}_{D} ( N - 1 ) < {B}_{T} ( N ) \\ Th + C & otherwise\end{matrix} \qquad [ Expression 4 ]$$

Here, C represents a value which determines redundancy for the threshold value.

For example, the operation will be described in a case in which the threshold value is assumed to be 0.25, the C is assumed to be −0.1, and the current target ratio of black display period is 0.2.

In the case as described above, when the discrete target ratio of black display period of the previous frame is 0, since the current target ratio of black display period (that is, the current target value) is a larger value than the discrete target ratios of black display period of the previous frame, the threshold value is 0.25 and, consequently, the discrete target ratio of black display period of the current frame is set to 0.

On the other hand, in a case in which the discrete target ratios of black display period of the previous frame are 0.5, since the current target ratio of black display period is smaller than the discrete target ratio of black display period of the previous frame, the threshold value is 0.25−0.1=0.15, and consequently, the discrete target ratio of black display period of the current frame is set to 0.5. In other words, by employing a variable threshold value as shown in Expression 4, stable single discrete target ratios of black display period can be obtained with respect to the target ratio of black display period in the vicinity of the threshold value.

When the value of C is set to a negative value, the threshold value when the discrete target ratio of black display period of the previous frame is 0.5 becomes a small value, and hence the discrete target ratio of black display period of the current frame can easily be set to 0.5. In other words, the ratio of black display period is stabilized to the target ratio of black display period which realizes a moving image in good quality.

In this embodiment, the discrete target ratios of black display period are set to two values of 0% and 50%. However, the discrete target ratios of black display period may be set to three or more values in the same manner. In this case, the discrete target ratios of black display period between which the current target ratio of black display period exists are inspected. For example, when the discrete target ratios of black display period are set to 0, 0.25 and 0.5, it can be obtained using Expression 5.

$${B}_{D , H} = \{ \begin{matrix}0.25 & {B}_{T} ( N ) < 0.25 \\ 0.5 & otherwise\end{matrix} \\ {B}_{D , L} = \{ \begin{matrix}0 & {B}_{T} ( N ) < 0.25 \\ 0.25 & otherwise\end{matrix} \qquad [ Expression 5 ]$$

In Expression 5, B_{D, H} is the maximum value of the discrete target ratio of black display period in which the target ratio of black display period is included, and B_{D, L} is the minimum value of the discrete target ratio of black display period in which the target ratio of black display period is included. Subsequently, the range of the discrete target ratio of black display period including the target ratio of black display period is determined by Expression 5, and then the threshold value is set by Expression 4 (the value of Th is set in advance for each range of discrete target ratio of black display period in which the target ratio of black display period is included), and finally, the discrete target ratio of black display period is calculated by Expression 6.

$${B}_{D} ( N ) = \{ \begin{matrix}{B}_{D , L} & {B}_{T} ( N ) < Th \\ {B}_{D , H} & otherwise\end{matrix} \qquad [ Expression 6 ]$$

(2-3) Black Display Period Ratio Change Amount Calculating Unit 18

The discrete target ratio of black display period obtained by the procedure described above is supplied to the black display period ratio change amount calculating unit 18, and the amount of change in ratio of black display period in one frame period is calculated. The amount of change in ratio of black display period is set to restrain flicker occurring due to an abrupt change in the current ratio of black display period (that is, the output value) as much as possible.

Here, the principle of occurrence of the flicker due to the abrupt change in ratio of black display period will be described.

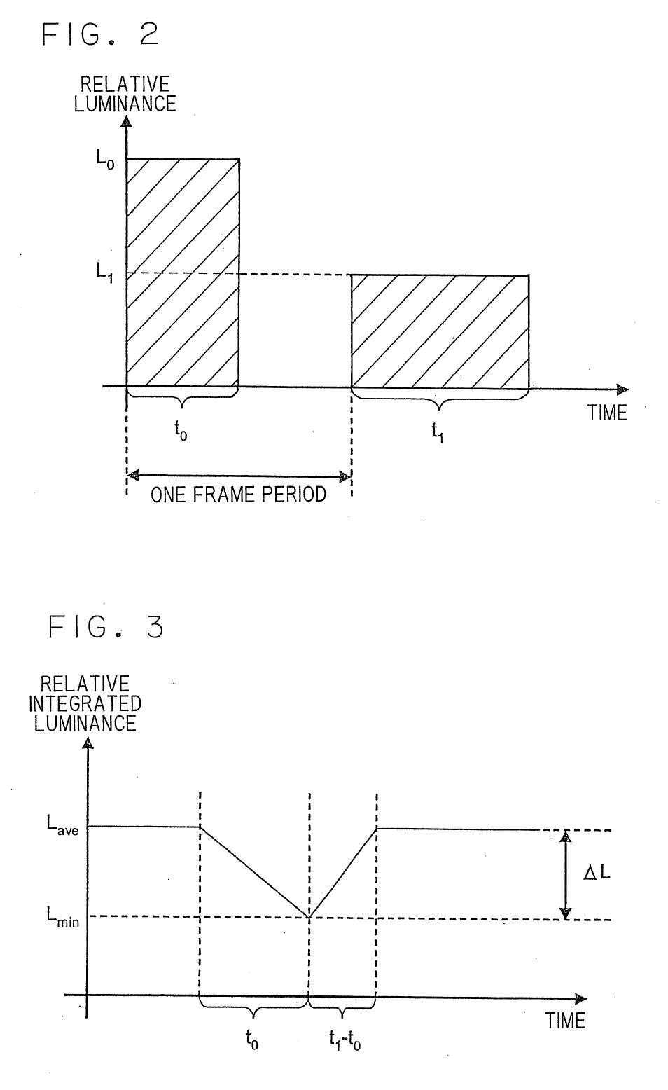

FIG. 2 is a pattern diagram showing a change in display luminance when the ratio of image display period (=1-ratio of black display period) is changed from t0 to t1 (t0<t1). The relative display luminance during the period t0 is assumed to be L0, and the relative display luminance during the period t1 is assumed to be L1. Since the average luminance of one frame period is constant irrespective of the ratio of image display period, Expression 7 is satisfied.
t₀L₀=t₁L₁=Lₐᵥₑ [Expression 7]

Subsequently, a relative integrated luminance during one frame period in a case in which the ratio of image display period is changed from t0 to t1 is considered. The humane eye perceives the brightness by integrating stimulation that the retina has received during a certain period. Therefore, the brightness which is perceived by integrating the luminance of the liquid crystal display device 10 during one frame period is modeled. FIG. 3 shows a temporal change in the relative integrated luminance during one frame period in a case in which the ratio of image display period is changed from t0 to t1. The horizontal axis represents time and the vertical axis represents the relative integrated luminance. When the ratio of image display period is constantly t0 or t1, the relative integrated luminance during the one frame period is a constant value Lave. However, at a timing when the ratio of image display period changes from t0 to t1, part of the relative luminance L0 at the time when the ratio of the image display period is t0 and part of the relative luminance L1 at the time when the ratio of the image display period is t1 are integrated in the one frame period, and hence the relative integrated luminance is changed to a smaller value as shown in FIG. 3. Assuming that a minimum value at this time is Lmin, the value of Lmin is expressed as Expression 8 using Expression 7.

$${L}_{min} = {t}_{0} {L}_{1} = \frac{{t}_{0}}{{t}_{1}} {L}_{ave} \qquad [ Expression 8 ]$$

Therefore, an amount of change ΔL in the relative integrated luminance is expressed as Expression 9.

$$Δ L = {L}_{ave} - {L}_{min} = ( 1 - \frac{{t}_{0}}{{t}_{1}} ) {L}_{ave} \qquad [ Expression 9 ]$$

A period Δt during which the relative integrated luminance is smaller than the value Lave is expressed as Expression 10 from FIG. 3.
Δt=t₀+(t₁−t₀)=t₁ [Expression 10]

Since the perceived flicker is considered to be proportional to the product of the amplitude of flicker (ΔL) and the period of occurrence of the flicker (Δt), the perceived flicker I is expressed as Expression 11.
I=αΔtΔL=α(t₁−t₀)Lₐᵥₑ=α|t₁−t₀|Lₐᵥₑ [Expression 11]

Here, α represents the constant of proportionality.

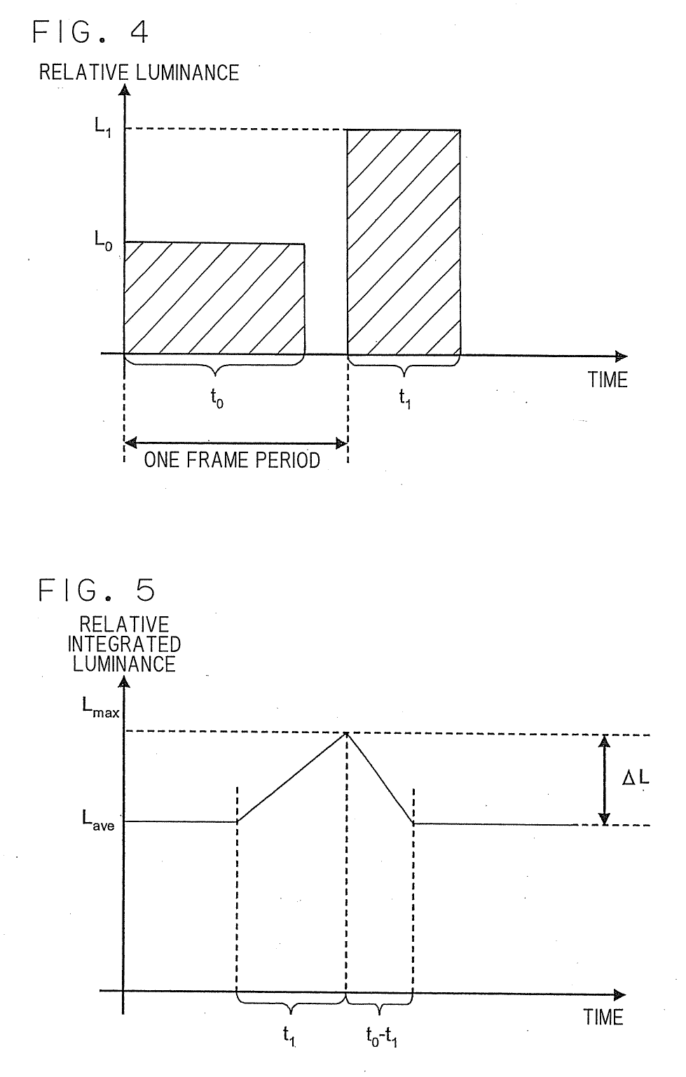

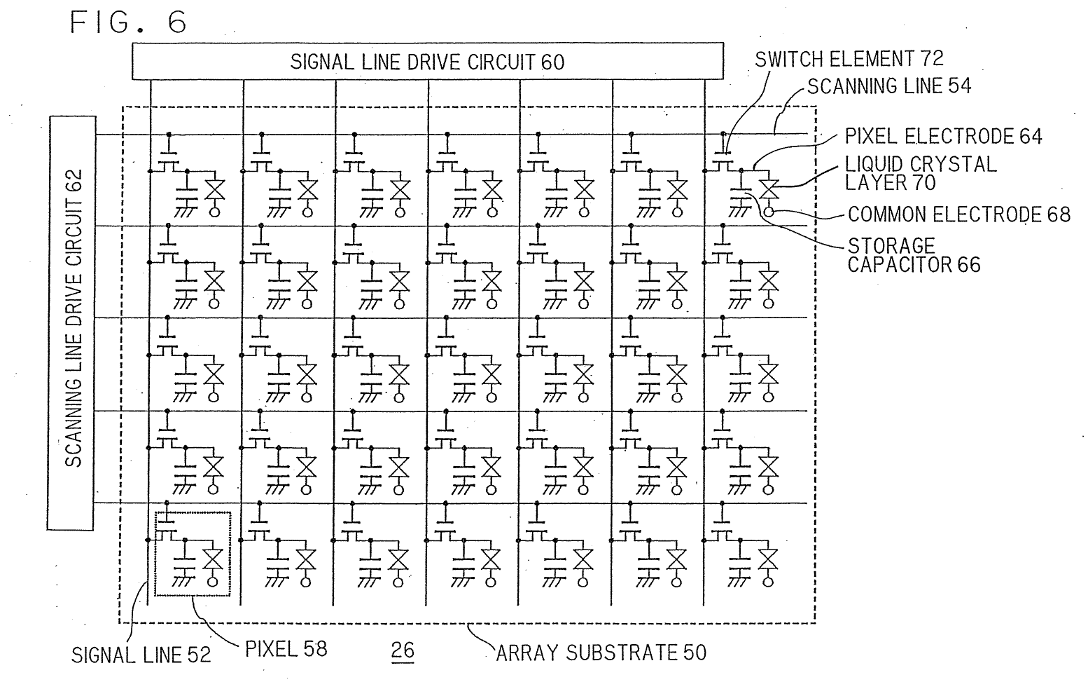

On the other hand, as shown in FIG. 4, a case in which the ratio of image display period is changed from t0 to t1 (t0>t1) is considered in the same manner, the relative integrated luminance during one frame period is as shown in FIG. 5. In other words, at a timing when the ratio of image display period is changed from t0 to t1, part of the relative luminance L0 at the time when the ratio of image display period is t0 and part of the relative luminance L1 at the time when the ratio of image display period is t1 are integrated in the one frame period, and hence the relative integrated luminance is changed to a large value as shown in FIG. 5. Assuming that the maximum value at this time is Lmax, the value of Lmax is expressed as Expression 12 using Expression 7.

$${L}_{max} = {t}_{1} {L}_{1} - ( {t}_{0} - {t}_{1} ) {L}_{0} = ( 1 + \frac{{t}_{0} - {t}_{1}}{{t}_{0}} ) {L}_{ave} \qquad [ Expression 12 ]$$

Therefore, the amount of change in relative integrated luminance ΔL is expressed as Expression 13.

$$Δ L = {L}_{max} - {L}_{ave} = ( 1 - \frac{{t}_{1}}{{t}_{0}} ) {L}_{ave} \qquad [ Expression 13 ]$$

The period Δt during which the relative integrated luminance is larger than Lave is expressed as Expression 14 from FIG. 5.
Δt=t₁+(t₀−t₁)=t₀ [Expression 14]

Therefore, perceived flicker I is expressed as Expression 15.
I=αΔtΔL=(t₀−t₁)Lₐᵥₑ=α|t₁−t₀|Lₐᵥₑ [Expression 15]

With the procedure described above, the flicker perceived when the ratio of image display period is changed from t0 to t1 is proportional to the amount of change in ratio of image display period, that is, the amount of change in ratio of black display period from Expression 11 and Expression 15. Therefore, by setting a transient black display period by the amount of change in ratio of black display period in which the perceived flicker is lower than recognizable limit, occurrence of the flicker due to the abrupt change in ratio of black display period can be restrained.

As shown above, when the change in ratio of black display period from frame to frame, or every plurality of frames is set to be abrupt, the flicker is perceived. Therefore, in this embodiment, the amount of change in black display period is set and the amount of change in ratio of black display period from frame to frame is set to 3%.

(2-4) Black Display Period Ratio Determining Unit 20

The amount of change in ratio of black display period set as described above is supplied to the black display period ratio determining unit 20, where the ratio of black display period to be finally outputted is calculated. The ratio of black display period is calculated by Expression 16.
B(N)=B(N−1)+Sgn(B_{D}(N)−B(N−1))ΔB [Expression 16]

In this expression, Sgn(x) represents a sign of x, ΔB represents the amount of change in ratio of black display period (0.03 in this embodiment) and B(N) represents the ratio of black display period of N^{th} frame. However, since B(N) is a value between the minimum ratio of black display period (0 in this embodiment) and the maximum ratio of black display period (0.5 in this embodiment), the ratio of black display period is corrected by Expression 17.

$$B ( N ) = \{ \begin{matrix}0 & B ( N ) < 0 \\ 0.5 & B ( N ) > 0.5 \\ B ( N ) & otherwise\end{matrix} \qquad [ Expression 17 ]$$

The calculated ratio of black display period is supplied to the black display period control unit 22 and the backlight luminance control unit 24.

(2-5) Black Display Period Control Unit 22

The black display period control unit 22 outputs the video signal and the control signal (horizontal, vertical synchronous signal, and so on) for driving the liquid crystal panel 26 in accordance with the calculated ratio of black display period.

(2-6) Liquid Crystal Panel 26

(2-6-1) Configuration of Liquid Crystal Panel 26

In this embodiment, the liquid crystal panel 26 is of an active matrix type, and as shown in FIG. 6, a plurality of signal lines 52 and a plurality of scanning lines 54 are arranged on an array substrate 50 via an insulating layer, not shown, in a matrix pattern, and pixels 58 are formed at respective intersecting points of the both lines. Ends of the signal lines 52 and the scanning lines 54 intersecting thereto are connected to a signal line drive circuit 60 and a scanning line drive circuit 62, respectively.

In the pixels 58, a switch element 72 composed of a thin film transistor (TFT) is the switch element 72 for writing a video signal, and gates of thereof in the respective horizontal line are connected to the common scanning line 54, and sources thereof in the respective vertical lines are connected to the common signal line 52. A drain is connected to a pixel electrode 64, and is connected to a storage capacitor 66 arranged in electrically parallel with the pixel electrode 64.

The pixel electrodes 64 are formed on the array substrate 50, and common electrodes 68 electrically opposite from the pixel electrodes 64 are formed on a common substrate, not shown. The common electrodes 68 are provided with predetermined common voltage from a common voltage generating circuit, not shown.

A liquid crystal layer 70 is held between the pixel electrodes 64 and the common electrodes 68, and the peripheries of the array substrate 50 and the common substrate are sealed by a sealing material, not shown. The liquid crystal material used for the liquid crystal layer 70 may be of any type, but preferably, the one which can respond relatively quickly since two image signals for image display and black display are required to be written during one frame period in the case of the liquid crystal panel 26 in this embodiment as described later. For example, ferroelectric liquid crystal and liquid crystal of OCB (Optically compensated Bend) mode are recommended.

The scanning line drive circuit 62 includes a shift register, a level shifter and a buffer circuit, not shown. The scanning line drive circuit 62 outputs a line selecting signal for the respective scanning lines 54 on the basis of a vertical start signal or a vertical clock signal outputted from a ratio of display control unit as a control signal.

The signal line drive circuit 60 includes an analogue switch, a shift register, a sample hold circuit, and a video bus, not shown. A horizontal start signal and a horizontal clock signal outputted from the ratio of display control unit as a control signal as well as a video signal are supplied to the signal line drive circuit 60.

(2-6-2) Operation of the Liquid Crystal Panel 26

Subsequently, the operation of the liquid crystal panel 26 will be described.

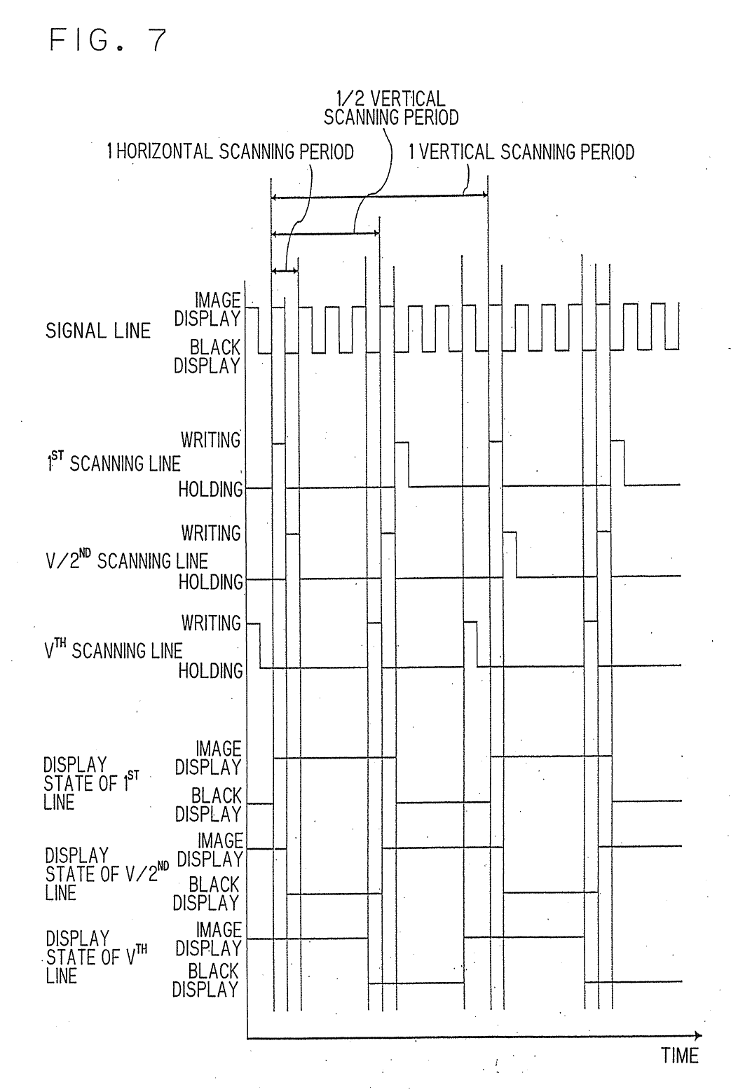

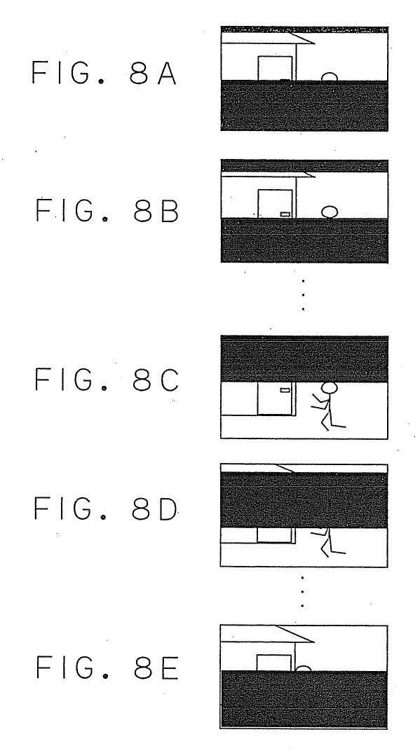

FIG. 7 is a timing chart of the liquid crystal panel 26.

FIG. 7 shows display signals outputted from the signal line drive circuit 60 and drive waveforms of the scanning line signals outputted from the scanning line drive circuit 62, and the states of image display on the liquid crystal panel 26. Although blanking periods are not shown in FIG. 7 for simplicity of the drawing, the drive signal of the general liquid crystal panel 26 has horizontal and vertical blanking periods.

An image display signal is outputted in a first half of one horizontal scanning period, and a black display signal is outputted in a second half thereof from the signal line drive circuit 60. In the scanning line drive circuit 62, scanning lines corresponding to the respective pixels 58 to which the image display signals should be supplied are selected in the first half of one horizontal scanning period, and scanning lines corresponding to the respective pixels 58 to which the black display signals should be supplied are selected in the second half of one horizontal scanning period.

FIG. 7 is a timing chart in the case in which the ratio of black display period is 50%. Representing the number of vertical scanning lines by V, when selecting the first scanning line in the first half of the one horizontal scanning period and supplying the image display signal to the corresponding pixel 58, the V/2+1^{st} scanning line is selected in the second half of the one horizontal scanning period to supply the black display signal to the corresponding pixel 58. In the same manner, When the second scanning line is selected in the first half of the one horizontal scanning period, the V/2+2^{nd} scanning line is selected in the second half of the one horizontal scanning line. In the same manner, the next scanning line is selected in the first half and the second half of the one horizontal scanning period in sequence. In this manner, when the V^{th} scanning line is selected in the first half of the one horizontal scanning period and the image display signal is supplied to the corresponding pixel 58, the V/2^{nd} scanning line is selected and the black display signal is supplied to the corresponding pixel 58 in the second half of the one horizontal scanning period.

FIG. 8 shows a displayed state on the liquid crystal panel 26 in the case in which the ratio of black display period is 50%.

FIG. 8A shows a displayed state when writing of the image display signal of n^{th} frame is completed until the V/2+1^{st} line and the black display signal is written into the first line.

FIG. 8B shows a displayed state when writing of the image display signal of the n^{th} frame is completed until the V/2+2^{nd} line and the black display signal is written into the second line.

FIG. 8C shows a displayed state when writing of the image display signal of the n^{th} frame is written into the V^{th} line and the black display signal is written into the V/2-1^{st} line.

FIG. 8D shows a displayed state when the image display signal of the n+1^{st} frame is written into the first line, and the black display signal is written into the V/2^{nd} line.

FIG. 8E shows a displayed state when the image display signal of the n+1^{st} frame is written into the V/2^{nd} line and the black display signal is written into the V^{th} line.

Although the case in which the ratio of black display period is 50% is shown in FIG. 7, desired black display period can be set by changing the timing to start writing the black display signal in the same manner, that is, by changing the timing of the scanning line signal. Therefore, the image can be displayed on the liquid crystal panel 26 at the desired ratio of black display period by outputting the control signal at the timing to start writing of the black display signal corresponding to the ratio of black display period from the black display period control unit 22 and inputting the same to the liquid crystal panel 26.

(2-7) Backlight Luminance Control Unit 24

The backlight luminance control unit 24 outputs a backlight luminance control signal for controlling a light source of the backlight 28 using supplied information on ratio of black display period.

In other words, it outputs an analogue voltage signal if the light source of the backlight 28 is an analogue-modulated LED, and it outputs a pulse width modulating signal if the light source is a pulse width modulated (PWM) LED. If the light source is a cold-cathode tube, it outputs an analogue voltage to be supplied to an inverter for illuminating the cold-cathode tube.

In this embodiment, an LED light source of a pulse width modulating system in which a large dynamic range of luminance can be ensured in a relatively simple configuration is employed. The relation between the pulse width to be supplied to the LED light source and the luminance of the backlight 28 is measured in advance, and stored in the backlight luminance control unit 24. As data to be stored may be, for example, a function when the relation described above can be represented by the function, or may be stored as LUT (Look-up Table) in a ROM.

When the LED light source has a configuration to display white by mixing the LEDs of three primary colors of red, green and blue, data for the respective LEDs is preferably stored.

Although a method of storing the relation between the pulse width and the luminance of the backlight 28 as data is shown in the example above, it is also possible to store the relation between the ratio of black display period and the pulse width in which the constant luminance is ensured on the liquid crystal display 26 on which display is made at various ratios of black display period. In other words, control is carried out so that a white image is displayed on the liquid crystal panel 26 at a certain ratio of black display period and the luminance of the backlight 28 is adjusted to be a predetermined luminance after having passed through the liquid crystal panel 26, and the pulse width which is being supplied at that time to the LED light source is obtained. The above described operation is performed at various ratios of black display period to obtain the relation between the ratio of black display period and the pulse width, and the results are stored as data. By referring the data at the supplied information on ratio of black display period, the luminance of the backlight 28 is controlled, and the luminance on the liquid crystal panel 26 can be maintained substantially at a constant value with respect to the arbitrary ratio of black display period.

In addition to the methods shown above, a method of installing a photodiode in the backlight 28, feeding back the luminance of the backlight 28 while measuring with the photodiode, and controlling the luminance of the LED light source is also applicable. In particular, since the LED light source varies in light-emitting characteristics depending on the temperature, the configuration of feeding back the measured values of luminance using the photodiode as described above is effective.

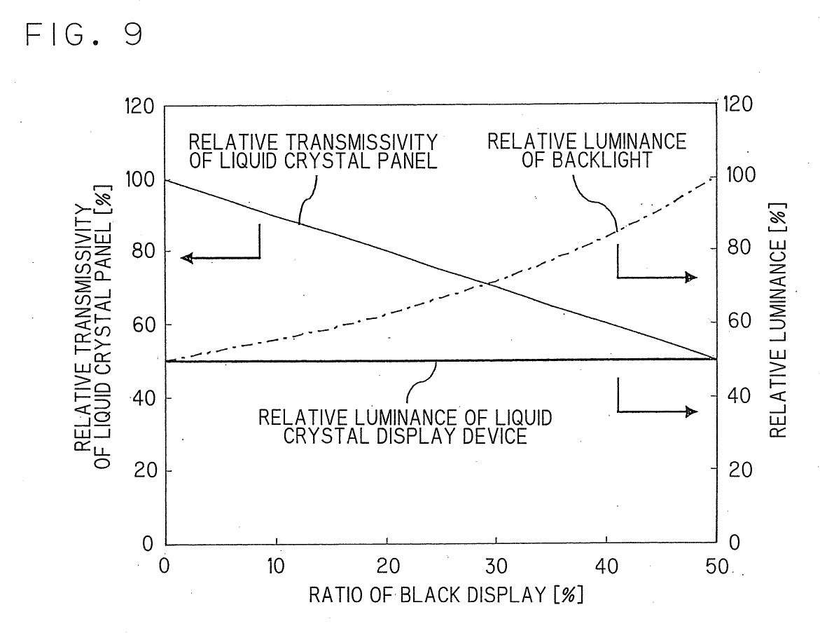

FIG. 9 shows a relation among the ratio of black display period , the relative transmissivity of the liquid crystal panel, the relative luminance of the backlight, and the relative luminance of the liquid crystal display device when the range of the ratio of black display period is set to 0% to 50%. The horizontal axis represents the ratio of black display period, the left vertical axis represents the relative transmissivity with respect to the transmissivity of the liquid crystal panel 26 when the ratio of black display period is 0%, and the right vertical axis represents the relative luminance with respect to the luminance of the backlight 28 when the ratio of black display period is 50%.

In the liquid crystal panel 26 used in this embodiment, the transmissivity is decreased linearly with increase in ratio of black display period. Therefore, the luminance of the backlight 28 is controlled in such a manner that the luminance of the backlight 28 increases with increase in ratio of black display period and the relative luminance of the liquid crystal display device 10, that is, the luminance after having passed through the liquid crystal panel 26 is kept at a constant value. With FIG. 9, the relation between the ratio of black display period and the relative luminance of the backlight 28 is obtained and, the relation between the ratio of black display period and the pulse width can be obtained from the relation between the relative illumination of the backlight and the pulse width to be supplied to the LED light source, and then, the luminance control signal for the backlight 28 represented by the pulse width can be obtained from the information on ratio of black display period obtained by the black display period ratio control unit 22.

Although the backlight 28 can be configured with various types of light sources described above, in this embodiment, a subjacent type backlight 28 having the LED as the light source is employed. However, the configuration of the backlight 28 is not limited to the one shown above and, for example, the edge light type backlight 28 having a light guide plate may also be employed. The backlight 28 is controlled in its luminance by the luminance control signal for the backlight 28 outputted from the backlight luminance control unit 24.

(3) Advantages

As described above, according to the liquid crystal display device 10 in this embodiment, the quality of displayed input video image can be improved while restraining increase in power consumption by changing the ratio of black display period depending on whether the input video image is a moving image or a still image.

In addition, flicker occurring due to an abrupt change in ratio of black display period can be restrained as much as possible.

The ratio of black display period can be stabilized for various video images.

### Second Embodiment

Subsequently, the liquid crystal display device 10 according to the second embodiment will be described.

The basic configuration of the liquid crystal display device 10 in this embodiment is the same as the one in the first embodiment. However, the operation of the target black display period ratio calculating unit 16 and the black display period ratio change amount calculating unit 18 is different from that of the first embodiment.

The target black display period ratio calculating unit 16 calculates the discrete target ratios of black display period by Expression 3 as in the first embodiment. However, the redundancy is not provided to the threshold value as in the first embodiment, and is a fixed value. In this embodiment, the discrete target ratios of black display period are calculated by applying the threshold processing to the target ratio of black display period. However, the above-described discretization is not essential, and the target ratio of black display period obtained from the movement information can be supplied as is to the black display period ratio change amount calculating unit 18.

The black display period ratio change amount calculating unit 18 calculates the amount of change in ratio of black display period for one frame according to the difference between the ratio of black display period of the previous frame and the supplied discrete target ratio of black display period using Expression 18.

$$Δ B = \{ \begin{matrix}Δ {B}_{1} & B ( N - 1 ) > {B}_{D} ( N ) \\ Δ {B}_{2} & otherwise\end{matrix} \qquad [ Expression 18 ]$$

In this expression, ΔB₁ and ΔB₂ represent the amounts of change in ratio of black display period for one frame in the cases where the discrete target ratio of black display period is smaller and larger than the ratio of black display period of the previous frame respectively.

The values of ΔB₁ and ΔB₂ may be various values. However, as described in the first embodiment as well, they are preferably set to a value not to exceed the amount of change at which flicker in association with the change in black display period is not viewed, and more preferably, they are set to satisfy the relation ΔB₁<ΔB₂. This is because the ratio of black display period can be stabilized to a large value, that is, to a state in which the good quality of moving image is ensured by setting the amount of change to be ΔB₁<ΔB₂ as in the first embodiment.

Expression 18 calculates the amount of change in ratio of black display period with the discrete target ratio of black display period as an input. However, a configuration to input the non-discretized target ratio of black display period can also be employed. In this case, Expression 18 is expressed as Expression 19.

$$Δ B = \{ \begin{matrix}Δ {B}_{1} & B ( N - 1 ) > {B}_{T} ( N ) \\ Δ {B}_{2} & otherwise\end{matrix} \qquad [ Expression 19 ]$$

Other configurations are the same as the first embodiment.

As described above, according to the liquid crystal display device 10 in this embodiment, the quality of the displayed input video image can be improved while restraining increase in power consumption by changing the ratio of black display period depending on whether the input video image is a moving image or a still image.

In addition, flicker occurring due to an abrupt change in ratio of black display period can be restrained as much as possible.

The ratio of black display period can be stabilized for various video images.

### Third Embodiment

Subsequently, the liquid crystal display device 10 according to the third embodiment will be described.

The basic configuration of the liquid crystal display device 10 in this embodiment is the same as the one in the first embodiment. However, the operation of the target black display period ratio calculating unit 16 and the black display period ratio change amount calculating unit 18 is different from that of the first embodiment.

The target black display period ratio calculating unit 16 calculates the discrete target ratios of black display period by Expression 3 as in the first embodiment. However, the redundancy is not provided to the threshold value as in the first embodiment, and is a fixed value.

In this embodiment, the discrete target ratios of black display period are calculated by applying the threshold processing to the target ratio of black display period. However, the above-described discretization is not essential, and the target ratio of black display period obtained from the movement information can be supplied as is to the black display period ratio change amount calculating unit 18.

The black display period ratio change amount calculating unit 18 calculates the amount of change in ratio of black display period on the basis of the difference values obtained by subtracting the ratios of black display period in the plurality of frames in the past from the discrete target ratios of black display period in the plurality of frames in the past respectively. More specifically, as shown in Expression 20, the amount of change in ratio of black display period is set to a predetermined value when all the difference values obtained by subtracting the ratios of black display period in the plurality of frames in the past time from the discrete target ratios of black display period in the plurality of frames in the past respectively are positive values or negative values, and is set to 0 in other cases.

$$Δ B = \{ \begin{matrix}Δ {B}_{1} & B ( N - i - 1 ) \geq {B}_{D} ( N - i ) ∀ i = 0 , 1 , Λ , n \\ Δ {B}_{2} & B ( N - i - 1 ) \leq {B}_{D} ( N - i ) ∀ i = 0 , 1 , Λ , n \\ 0 & otherwise\end{matrix} \qquad [ Expression 20 ]$$

In Expression 20, the amount of change in ratio of black display period is calculated on the basis of the differences between the discrete target ratios of black display period and the ratios of black display period in n frames in the past. In this embodiment, the value of n is assumed to be 4 (n=4).

In Expression 20, the different amount of change in ratio of black display period is employed depending on whether the differential values are positive values or negative values including the configuration according to the second embodiment. However, ΔB, and ΔB₂ may be the same value. In this configuration, even when the discrete target ratios of black display period are varied to some extent by the erroneous detection of the movement information, the amount of change in ratio of black display period is set to 0. Therefore, a stable ratio of black display period can be obtained.

In Expression 20, the discrete target ratios of black display period are supplied as input. However, a configuration in which the target ratio of black display period is supplied as input as in Expression 21 is also applicable.

$$Δ B = \{ \begin{matrix}Δ {B}_{1} & B ( N - i - 1 ) \geq {B}_{T} ( N - i ) ∀ i = 0 , 1 , Λ , n \\ Δ {B}_{2} & B ( N - i - 1 ) \leq {B}_{T} ( N - i ) ∀ i = 0 , 1 , Λ , n \\ 0 & otherwise\end{matrix} \qquad [ Expression 21 ]$$

Other configurations are the same as the first embodiment.

As described above, according to the liquid crystal display device 10 in this embodiment, the quality of the displayed input video image can be improved while restraining increase in power consumption by changing the ratio of black display period depending on whether the input video image is a moving image or a still image.

In addition, flicker occurring due to an abrupt change in ratio of black display period can be restrained as much as possible.

The ratio of black display period can be stabilized for various video images.

### Fourth Embodiment

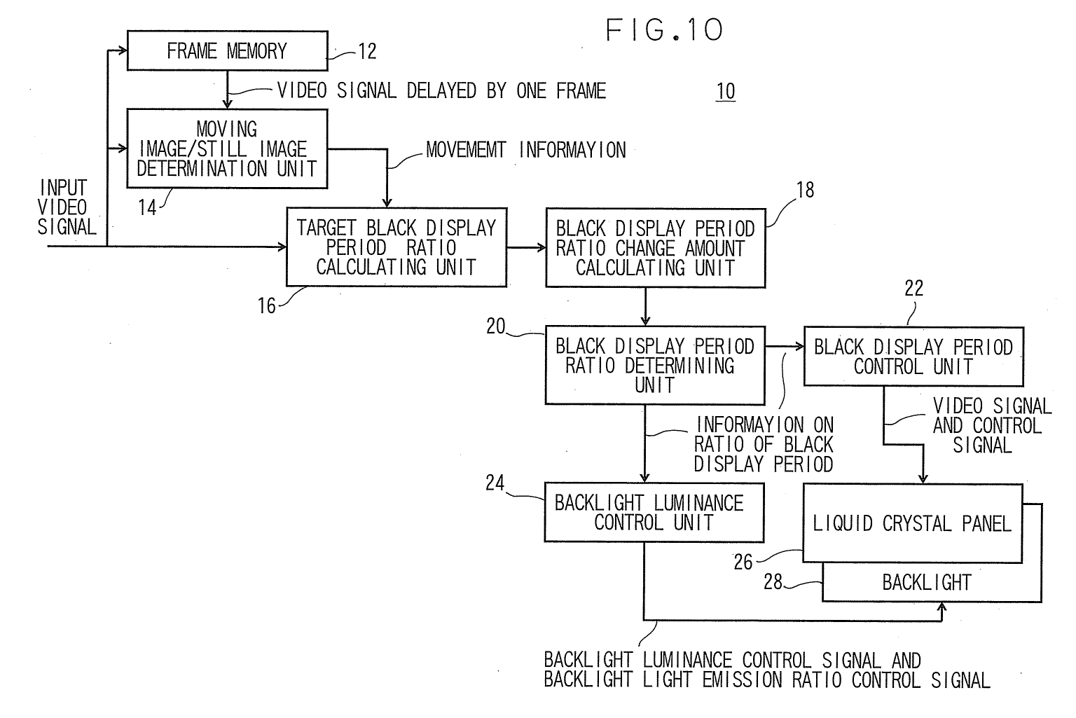

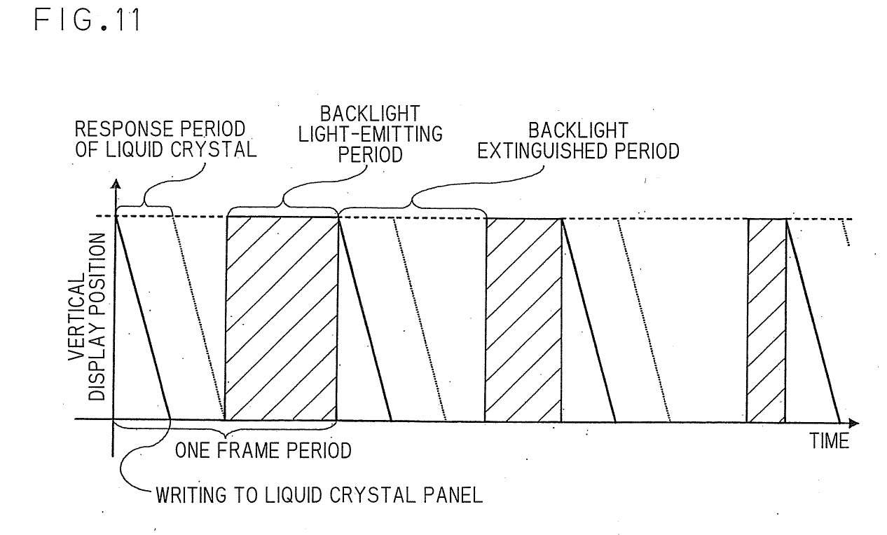

Subsequently, referring to FIG. 10 and FIG. 11, the liquid crystal display device 10 according to the fourth embodiment will be described.

(1) Configuration of Liquid Crystal Display Device 10

FIG. 10 shows a configuration of the liquid crystal display device 10 according to this embodiment.

The basic configuration of the liquid crystal display device 10 in this embodiment is the same as the one in the first embodiment, and is characterized in that the ratio of black display period of an input video image displayed on the liquid crystal display device 10 is controlled by controlling lighting and extinction of the backlight 28.

The ratio of black display period is determined from the input video image by the same configuration as in the first embodiment. The determined ratio of black display period is supplied to the backlight luminance control unit 24 as information on ratio of black display period. The backlight luminance control unit 24 determines the light-emitting period of the backlight 28 and the light-emitting luminance of the backlight 28 on the basis of the information on ratio of black display period, and supplies the same to the backlight 28 as a ratio of light emission control signal for the backlight 28 and a luminance control signal for the backlight 28. The backlight 28 emits light on the basis of the supplied ratio of light emission control signal for the backlight 28 and the luminance control signal for the backlight 28.

(2) The Operation of the Liquid Crystal Panel 26 and the Backlight 28

Subsequently, the operation of the liquid crystal panel 26 and the backlight 28 will be described.

In FIG. 11, the operation of the liquid crystal panel 26 and the backlight 28 is shown. In FIG. 11, the horizontal axis represents time and the vertical axis represents a vertical display position of the liquid crystal panel 26.

Normally, in the liquid crystal panel 26, a video image is written into line sequence from the top of the screen as one faces. Therefore, writing to the liquid crystal panel 26 is performed in such a manner that the video image is written into the liquid crystal panel 26 while shifting the writing time little by little from the top of the screen as one faces as shown in FIG. 11. In order to secure the light-emitting period of the backlight 28, described later, writing into the liquid crystal panel 26 is performed while spending one frame period (generally, 1/60 second). However, in this embodiment, it is written into a period shorter than one frame period, that is, ¼ frame period ( 1/240 second). When a predetermined period from a timing when the video image is written into a lower most line of the liquid crystal panel 26 until the completion of response of the liquid crystal has elapsed, the backlight 28 emits light according to the light emission ratio control signal for the backlight 28.

The light-emitting luminance of the backlight 28 is determined by the light-emitting period of the backlight 28, and control is made to make the product of the light-emitting period and the light-emitting luminance of the backlight 28 become substantially constant.

The backlight 28 is preferably extinguished during the period of writing in the liquid crystal panel 26 and the response period of the liquid crystal. It is because part of a video image in the previous frame is displayed on the liquid crystal panel 26 during the period of writing in the liquid crystal panel 26 and the response period of the liquid crystal, and hence if the backlight 28 emits light during this period, the previous frame and the current frame are perceived to an observer in mixture.

By controlling the light-emitting period of the backlight 28 as described above, the ratio of black display period of the liquid crystal display device 10 can be controlled as in the first embodiment.

(3) Advantages

As described above, according to the liquid crystal display device 10 in this embodiment, the quality of the displayed input video image can be improved while restraining increase in power consumption by changing the ratio of black display period depending on whether the input video image is a moving image or a still image.

In addition, flicker occurring due to an abrupt change in ratio of black display period can be restrained as much as possible.

The ratio of black display period can be stabilized for various video images.

### Fifth Embodiment

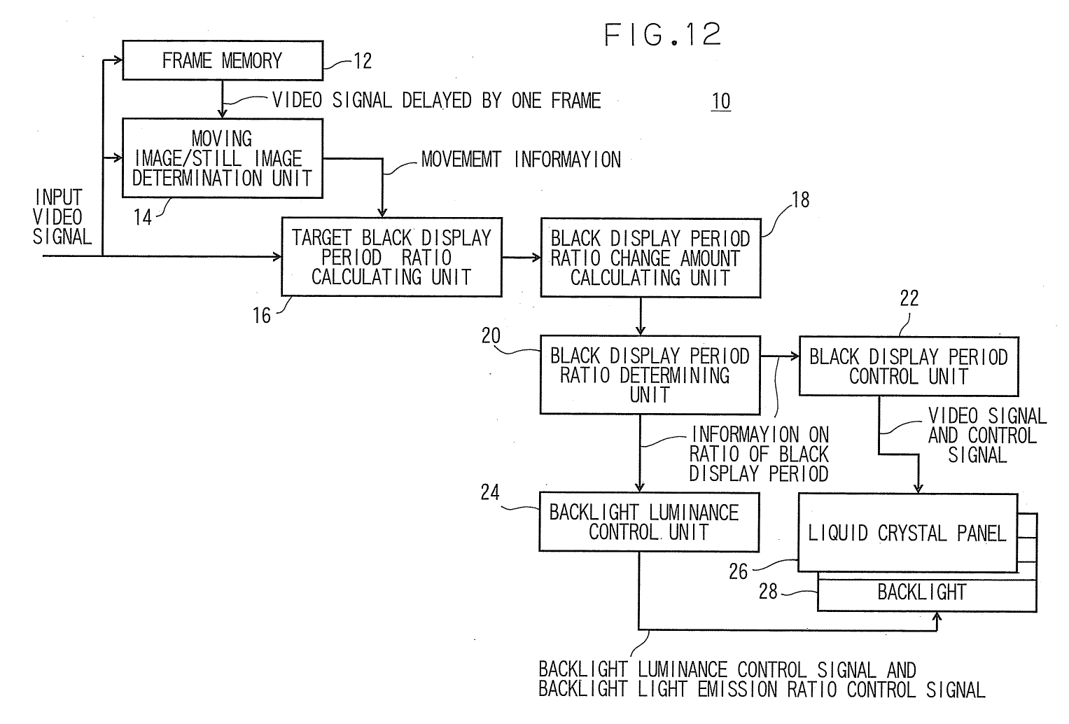

Subsequently, referring to FIG. 12 to FIG. 14, the liquid crystal display device 10 according to a fifth embodiment of the invention will be described.

(1) Configuration of the Liquid Crystal Display Device 10.

FIG. 12 shows a configuration of the liquid crystal display device 10 in this embodiment.

The basic configuration of the liquid crystal display device 10 in the fifth embodiment is the same as the one in the fourth embodiment. However, the light-emitting area of the backlight 28 is divided so that the backlight 28 can be emitted at different timings.

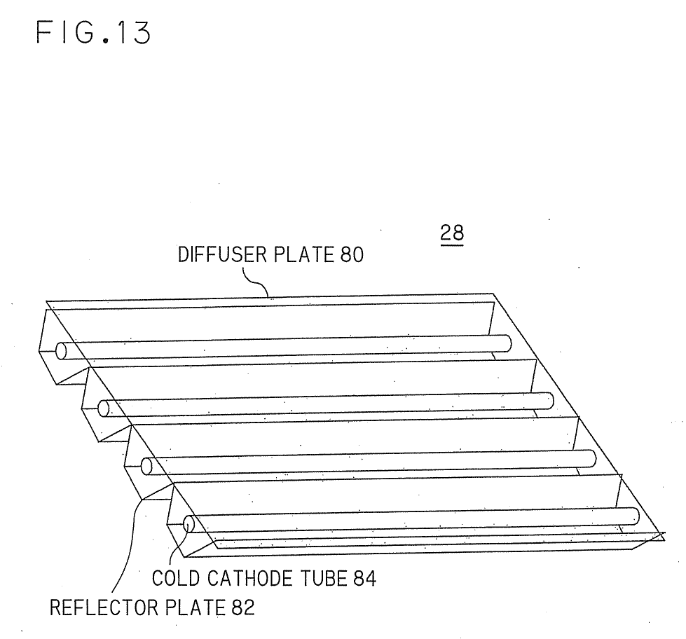

An example of the structure of the backlight 28 is shown in FIG. 13.

FIG. 13 is a structure referred to as a subjacent type backlight 28, which includes cold cathode tubes 80 aligned as light sources and the respective cold cathodes tubes 80 surrounded by a reflector plate 82. A diffuser panel 84 is installed above the cold cathode tubes 80 to diffuse light from the cold cathode tubes 80 so that a uniform surface light source is achieved. In this embodiment, the timings of light emission of the respective cold cathode tubes 80 are differentiated.

(2) Operation of the Liquid Crystal Panel 26 and the Backlight 28

Subsequently, the operation of the liquid crystal panel 26 and the backlight 28 will be described.

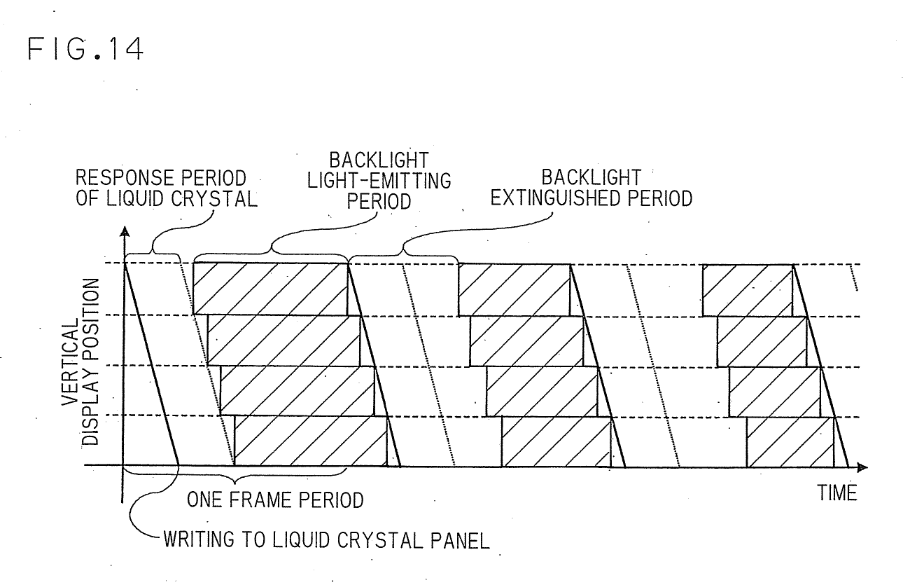

FIG. 14 shows the operation of the liquid crystal panel 26 and the backlight 28.

In FIG. 14, the backlight 28 is divided into four parts in the horizontal direction, and the respective areas can control the timings of light emission and extinction of the backlight 28. In the fourth embodiment, the timing of light emission of the backlight 28 is when a predetermined period has elapsed after the writing into the lower most line of the liquid crystal panel 26 is completed. However, in this embodiment, the respective parts of the backlight 28 emit light when the response period of the liquid crystal has elapsed after the writing into the lower most line of the liquid crystal panel 26 corresponding to the divided area is completed according to the light emission ratio control signal for the backlight 28. In the case in which the light-emitting area of the backlight 28 is divided, the light-emitting period of the backlight 28 can be elongated with respect to the case of the fourth embodiment, and hence control of the ratio of black display period can be achieved in a larger area.

Other configurations are the same as the first embodiment.

(3) Advantages

As described above, according to the liquid crystal display device 10 in this embodiment, the quality of the displayed input video image can be improved while restraining increase in power consumption by changing the ratio of black display period depending on whether the input video image is a moving image or a still image.

In addition, flicker occurring due to an abrupt change in ratio of black display period can be restrained as much as possible.

The ratio of black display period can be stabilized for various video images.

### Sixth Embodiment

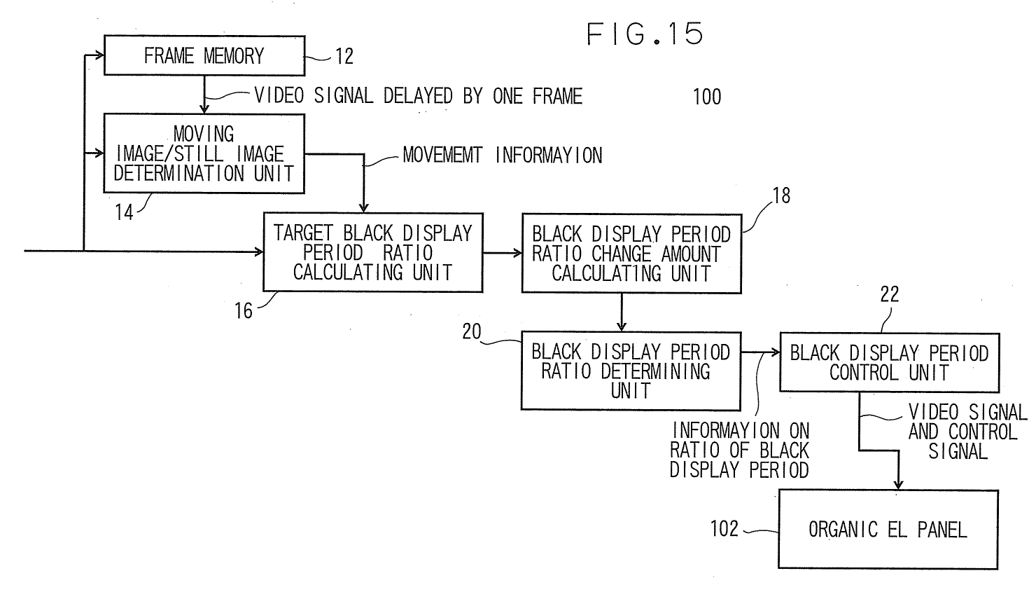

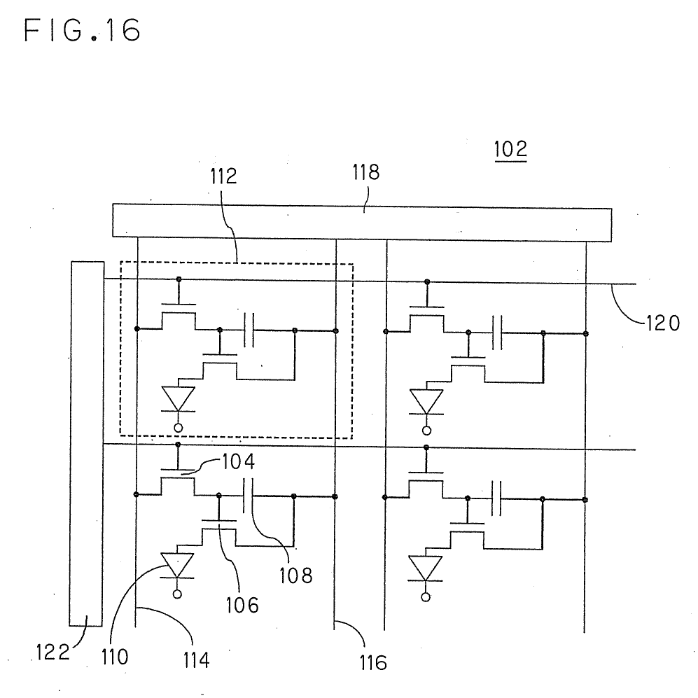

Referring now to FIG. 15 and FIG. 16, an organic EL display 100 as the image display device in a sixth embodiment will be described.

(1) Configuration of the Organic EL Display 100

FIG. 15 shows a configuration of the organic EL display 100 according to this embodiment.

The basic configuration of the organic EL display 100 is the same as the one in the first embodiment. However, the image display unit is configured with an organic EL panel 102.

FIG. 16 shows an example of the configuration of the organic EL panel 102. In the organic EL panel 102, a pixel 112 includes a first switch element 104, a second switch element 106 formed of two thin film transistors, a voltage holding capacity 108 for holding a voltage supplied from the signal line 52, and an organic EL element 110, and ends of signal lines 114 and power source lines 116 are connected to a signal line drive circuit 118, and scanning lines 120 extending in the direction orthogonal to the signal lines 114 and the power source lines 116 are connected to a scanning line drive circuit 122.

(2) Operation of the Organic EL Display 100

Subsequently, the operation of the organic EL display 100 will be described.

A scanning line drive signal in the ON state is applied to the first switch element 104 via the scanning line 120 by the scanning line drive circuit 122, so that the first switch element 104 is brought into the conducting state. At this time, a signal line drive signal outputted from the signal line drive circuit 118 is written into the voltage holding capacity 108 via the signal line. The conducting state of the second switch element 106 is determined according to the amount of electric charge accumulated in the voltage holding capacity 108, and an electric current is supplied from the power source line 116 to the organic EL element 110 to cause the organic EL element 110 to emit light. Even when the scanning line drive signal is brought into the OFF state, since the voltage which determines the conducting state of the second switch element 106 is accumulated in the voltage holding capacity 108, the electric current is continuously supplied from the power source line 116 to the organic EL element 110.

Therefore, in the same manner as FIG. 7 in the first embodiment, a video signal is outputted in the first half of one horizontal scanning period, and a black video signal is outputted in the second half thereof from the signal line drive circuit 118. Then, a scanning line drive signal in the ON state which is in synchronous with the first half of the one horizontal scanning period is applied to the scanning line 120 for writing the video signal and a scanning line drive signal in the ON state which is in synchronous with the second half of the one horizontal scanning period is applied to the scanning line 120 for writing the black video signal, so that the video image display period and the black video image display period of the organic EL panel 102 can be controlled as in the first embodiment.

In other words, the scanning line drive circuit 122 is controlled on the basis of the ratio of black display period determined by the display ratio control unit as in the first embodiment. However, since the organic EL panel 102 is a self-light-emitting element, it is necessary to control the brightness of the video image in the period in which the video image is displayed according to the ratio of black display period to make the luminance of the one frame period substantially constant.

Therefore, in this embodiment, the brightness of the video image is controlled digitally using the signal line drive circuit 118 provided with an output accuracy of 10 bits. A state in which the brightness is required in the video image most is a state in which the ratio of black display period becomes the maximum in a predetermined control range. In other words, since the ratio of black display period is large, the period for displaying the video image becomes shorter, and hence the brightness of the video image is required to be increased in order to achieve a substantially constant luminance in the one frame period.

Therefore, the maximum number of display tones of the video image at the moment when the highest ratio of black display period is reached in the predetermined range of controlling the ratio of black display period is set to 1020 tones, and the maximum luminance in the video image display period is controlled by reducing the maximum number of display tones of the video image to a smaller value as the ratio of black display period is reduced. In other words, assuming that a gamma value of the input video image is γ, the maximum number of tones of the input video image is 8 bits (255 tones), and the ratio of the luminance during the video image display period at the desired ratio of black display period with respect to the luminance during the video image display period at the maximum ratio of black display period in the range of controlling the ratio of black display period is I, the maximum tone Lmax which is set when the ratio of the luminance is I is expressed by Expression 22.
Lₘₐₓ=(I×(255×4)^{γ})^{1/γ} [Expression 22]

The brightness during the video image display period can be controlled by obtaining the maximum tone according to the ratio of black display period by Expression 22 and then re-quantizing all the tones in the video image.

The brightness of the organic EL panel 102 can also be controlled by controlling the current value supplied by the power source lines 116. Therefore, a configuration in which the current value supplied from the power source lines 116 is controlled so as to achieve a substantially constant luminance during one frame period according to the ratio of black display period may also be employed.

Other configurations and operations are the same as in the first embodiment.

(3) Advantages

As described thus far, according to the liquid crystal display device 10 in the embodiment, the quality of the displayed input video image can be improved while restraining increase in power consumption by changing the ratio of black display period depending on whether the input video image is a moving image or a still image.

In addition, flicker occurring due to an abrupt change in ratio of black display period can be restrained as much as possible.

The ratio of black display period can be stabilized for various video images.

What is claimed is:

1. An image display device comprising:
an image display unit;
a target value calculating unit configured to calculate a target value of a ratio of black which corresponds to a ratio of black display period occupied in one frame period of an input image;
a change amount calculating unit configured to obtain an amount of change per unit period of an output value of the ratio of black within a range in which occurrence of flicker in the unit period can be restrained on the basis of
(1) the difference between the target value and a output value of a previous frame or
(2) the difference between the target value and the target value obtained in the past;
an output value calculating unit configured to obtain a output value of the ratio of black for displaying a current frame by adding the amount of change to the output value of the previous frame; and
a control unit configured to divide the one frame period into two periods of
(1) a first period which corresponds to the output value of the current frame and
(2) a second period which corresponds to a remaining period of the first period and
making a control to cause the image display unit to display a black image during the first period and to cause the image display unit to display an image on the basis of the input image during the second period.

2. The image display device according to claim 1, wherein the target value is a discrete target value discretized by an arbitrary threshold value.

3. The image display device according to claim 2, wherein the threshold value is determined on the basis of the difference between the discrete target value of a frame preceding the current frame by one or a plurality of frames and a current target value.

4. The image display device according to claim 3, wherein the threshold value when the differential value is a positive value is differentiated from the threshold value when the differential value is a negative value.

5. The image display device according to claim 3, wherein a threshold value in a case in which the discrete target value of the frame preceding the current frame by one or the plurality of frames is smaller than the current target value is larger than a threshold value in a case in which the discrete target value of the frame preceding the current frame by one or the plurality of frames is larger than the current target value.

6. The image display device according to claim 2, wherein an absolute value of the amount of change in a case in which the discrete target value is smaller than the output value of the previous frame is smaller than an absolute value of the amount of change in a case in which the discrete target value is larger than the output value of the previous frame.

7. The image display device according to claim 1, wherein the amount of change is determined in such a manner that;
(1) the amount of change in the ratio of black is set to a positive value when differential values obtained by subtracting the output values of arbitrary number of frames in the past respectively from the target values of the arbitrary number of frames in the past are positive values for all the arbitrary number of frames in the past,
(2) the amount of change in the ratio of black is set to a negative value when the differential values for all the arbitrary number of frames in the past are negative values, and
(3) the amount of change is set to zero in other cases.

8. The image display device according to claim 1, wherein the image display unit at least comprises a liquid crystal panel, a surface light source unit installed on the back side of the liquid crystal panel and illuminates the liquid crystal panel from the back side and a display luminance control unit configured to control the luminance of the surface light source unit,
the control unit controls the liquid crystal panel to display the input image and the black image on the basis of the ratio of black, and
the display luminance control unit controls the luminance so that variation in luminance of the image display unit in one frame period caused by the change in ratio of black falls within an arbitrary range.

9. The image display device according to claim 1, wherein the image display unit comprises a liquid crystal panel, a surface light source unit installed on the back side of the liquid crystal panel and illuminates the liquid crystal panel from the back side and a display luminance control unit configured to control the luminance of the surface light source unit,
the control unit controls the liquid crystal panel to display the input image during the one frame period, and
the display luminance control unit controls the luminance in a light-emitting period of the surface light source unit so as
(1) to cause the surface light source unit to emit light during a period in which the input image is to be displayed,
(2) to cause the surface light source unit to extinguish during a period in which the black image is to be displayed, and
(3) to restrain the variations in luminance during one frame period caused by the change in ratio of black within an arbitrary range on the basis of the ratio of black.

10. The image display device according to claim 9, wherein the surface light source unit can control the timings of light emission and extinction for each of a plurality of horizontal light-emitting areas divided in the vertical direction in the screen of the liquid crystal panel,
the input image data is written into the liquid crystal panel from an end of a screen in line sequence by each horizontal line,
the display luminance control unit controls in such a manner that
(1) after the input image is written into the display area of the liquid crystal panel corresponding to the divided horizontal light-emitting area by the control unit, the horizontal light-emitting area is extinguished according to the black display period, and then the horizontal light-emitting area is caused to emit light according to a period other than the black display period, or
(2) after the input image is written into the display area corresponding to the divided horizontal light-emitting area by the control unit, the horizontal light-emitting area is caused to emit light according to the period other than the black display period, and then the horizontal light-emitting area is extinguished according to the black display period.

11. The image display device according to claim 1, wherein the image display unit is an electro luminescence panel.

12. An image display method comprising:
obtaining a target value of the ratio of black which is the ratio of a black display period occupying one frame period of an input image displayed on an image display unit;
obtaining the amount of change of an output value of the ratio of black per unit period in a range which can restrain occurrence of flicker within the unit period on the basis of
(1) the difference between the target value and an output value of the previous frame or
(2) the difference between the target value and the target value obtained in the past,
adding the amount of change to the output value of the previous frame to obtain a output value of the ratio of black for displaying a current frame,
dividing the one frame period into two periods of
(1) a first period which corresponds to the output value of the current frame and
(2) a second period which corresponds to a remaining period of the first period
making a control to cause the image display unit to display a black image in the first period and
causing the image display unit to display an image on the basis of the input image in the second period.

13. The image display method according to claim 12, wherein the target value is a discrete target value discretized by an arbitrary threshold value.

14. The image display method according to claim 13, wherein the threshold value is determined on the basis of the difference between the discrete target value of a frame preceding the current frame by one or a plurality of frames and a current target value.

15. The image display method according to claim 14, wherein the threshold value when the differential value is a positive value is differentiated from the threshold value when the differential value is a negative value.

16. The image display method according to claim 14, wherein a threshold value in a case in which the discrete target value of the frame preceding the current frame by one or the plurality of frames is smaller than the current target value is larger than a threshold value in a case in which the discrete target value of the frame preceding the current frame by one or the plurality of frames is larger than the current target value.

17. The image display method according to claim 13 wherein an absolute value of the amount of change in a case in which the discrete target value is smaller than the output value of the previous frame is smaller than an absolute value of the amount of change in a case in which the discrete target value is larger than the output value of the previous frame.

18. The image display method according to claim 12, wherein the amount of change is determined in such a manner that;
(1) the amount of change in the ratio of black is set to a positive value when differential values obtained by subtracting the output value of arbitrary number of frames in the past respectively from the target values of the arbitrary number of frames in the past are positive values for all the arbitrary number of frames in the past,
(2) the amount of change in the ratio of black is set to a negative value when the differential values for all the arbitrary number of frames in the past are negative values, and
(3) the amount of change is set to zero in other cases.
